(19) United States
(12) Patent Application Publication
(10) Pub. No.: US 2010/0139566 A1
(43) Pub. Date: Jun. 10, 2010

(54) STORAGE BOXES FOR SEA WORMS AND CORRESPONDING PACKAGING

(75) Inventor: Michel Lopuszanski, Cormelles Le Royal (FR)

Correspondence Address: BANNER & WITCOFF, LTD., 1100 13th STREET, N.W., SUITE 1200, WASHINGTON, DC, 20005-4051, US

(73) Assignee: NORMANDIE APPATS, Ranville (FR)

(21) Appl. No.: 12/669,526

(22) PCT Filed: Jul. 18, 2008
(86) PCT No.: PCT/FR08/01071

§ 371 Date: Feb. 9, 2010

(30) Foreign Application Priority Data
Jul. 18, 2007 (FR) 0705191

(51) Int. Cl. A01K 97/04; B65D 21/032; A01K 29/00

(52) U.S. Cl. 119/6.7; 206/515; 43/55

(57) ABSTRACT

This involves a box, a box stack and a packaging for storage boxes for bloodworms, made of substantially parallelepipedal plastic. Each box comprises a container for retaining the bloodworms and their medium of isosceles trapezoidal section and having a surround the periphery of which is perpendicular to the bottom at a distance from the outer face of the lateral walls and with a height of between ¼ and ⅔ of the height of said container. The surround comprises stiffening lugs with a length greater than its height, arranged so that, when the upper container is fitted onto a lower container, the resting of the lugs of the upper surround on the top of the lower surround provides on the one hand a space for retaining the worms and their medium between the lower face of the upper container and the upper face of the lower container and, on the other hand, a zigzag empty space between the volume of air trapped between said faces and the outside of the containers.

The present invention relates to a storage box for bloodworms made of substantially parallelepipedal plastic.

It also relates to a packaging for a set of containers for bloodworms belonging to such boxes.

The invention finds a particularly important, although not exclusive, application in the field of storage of American worms, called “bloodworms”, originating from the North American continent, for example for their importation into Europe by air. Such bloodworms are used as live bait for leisure fishing at sea.

Already known are storage systems for live bloodworms allowing them to be transported by air. Such systems consist in large cardboard boxes containing a newspaper bottom covered with a bed of fresh and damp seaweed, allowing the transport of the order of one hundred to one hundred and thirty live worms per box. Usually, a coolant is inserted into the box when it is filled in order to maintain a certain coolness during transport which lasts approximately sixty hours before reaching the point of sale in a fishing store.

Such a system has drawbacks. Specifically, the merchandise cannot be resold as is to the fishermen because a box of a hundred worms is too large a unit for retail sale.

It is therefore necessary to insert into the process a sorting operation, with counting, of the worms before they are repackaged in smaller quantities. In particular, the retailer will have to divide the content by extracting the healthy worms from the seaweed of the boxes, one by one, before transferring them into small receptacles previously furnished with an added medium. This medium is usually formed by a small quantity of washed seaweed originating from the initial box. A layer of damp sand is sometimes also used, but poses a problem of dosing, the number of worms per box then varying from 5 to 10, depending upon requirements.

Such systems are time-consuming. Retailers have little time to dedicate to sorting because they are primarily absorbed by their sales activity at the counter. This work is also tricky and requires dexterity. It is dirty work, which requires frequent washing of the hands of the vendors which must be clean and dry in order to properly use the keypad of the cash register or of the computer and/or for handling the change.

Note here that the retailer has only a few opportunities to do such work before or after opening his store, the latter opening early and closing late, for the needs of his business with leisure fishermen.

Such sorting requires surface areas or worktops that often do not exist in a fishing store. This time wasted on packaging makes the clients wait if the store is full and has a material cost since in addition to the initial storage boxes provided for transport, it is necessary to provide a second set of smaller boxes for sale, a cost which falls to the retailer.

Moreover, the latter does not have control of the cost of the worms per se. Specifically it is he who takes on most of the risk associated with unpleasant surprises when sorting the worms into small quantities because of the presence of worms that are dead, unsuitable for sale because they are too small or even fewer in number than planned (bad counting at the outset, which may or may not be intentional).

Such a discount is currently of the order of 10 to 15%.

The result of this is disputes with the wholesaler because of this bulk sale and/or of the added costs on the box if the wholesaler takes responsibility for this repackaging which is currently practically only carried out at the retailer's.

The object of the present invention is to alleviate these drawbacks. For this purpose it starts with an entirely novel idea in the context of storing live bloodworms for this type of air transport, namely to provide itemized storage in small boxes or containers at the source, that is to say virtually at the moment of picking them up with an average cost per worm that is lower than or equal to the current cost, while guaranteeing worms of superior quality.

The reason for this is that the latter are subjected to better conservation because they will arrive fresher, with less handling and better sorted, with a reliable number of worms per box, which limits or prevents losses for the retailers.

The latter also avoid the tiresome and stressful work of sorting on site to the detriment of their customers.

Certainly, cardboard, polystyrene or even plastic packages are known for a limited quantity of worms.

Such boxes are however not easy to fill at a high rate, for example semiautomatically.

Neither are they easy to take hold of by the users to be moved en bloc.

Designed to contain a seaweed or sand medium which must remain damp, they are not easy to dampen or redampen. In particular, a medium of the wet sand type (nevertheless preferred for the worms), a medium which tends to dry out, is difficult to use.

Finally, these boxes take up space, are not easy to store and immobilize together in one and the same refrigerated packaging.

The object of the present invention is to provide a box and a packaging that respond better than those known before to the requirements of the practice, particularly in that it allows easy storage of the worms in self-breathing containers with sealed walls, that can be stacked on top of one another with their content, that are easy to take hold of and to arrange in groups in the packaging and which, although having no lid, ensure that the worms (which cannot get out because of the stacking) are immobilized.

The stackability of the filled boxes also considerably reduces the volume for storage and transport of the full boxes. This new box also provides an easy possibility of rinsing the content that is particularly practical and very fast, and of redampening the media, with all the boxes stacked.

For this purpose, the present invention essentially proposes a storage box for bloodworms, made of substantially parallelepipedal plastic, characterized in that it comprises a container for retaining the bloodworms and their medium of isosceles trapezoidal lateral, longitudinal and transverse sections directed downward, said container having solid walls with an upper edge furnished with a surround the periphery of which is perpendicular to the bottom and situated entirely at a distance from the outer face of the lateral walls, and extends downward over a height of between ¼ and ⅔ of the height of said container (for example ⅓), said surround comprising stiffening lugs perpendicular to said surround, evenly placed along said surround, and with a length greater than the height of said surround, said lugs being arranged so that, when the “upper” container is fitted onto a “lower” container, the resting of the lugs of the upper surround on the top of the lower surround provides on the one hand a space for retaining the worms and their medium between the lower face of the upper container and the upper face of the lower container and, on the other hand, a zigzag empty space between the volume of air trapped between said faces and the outside of the containers.

Advantageously, the empty space between the lower faces of two stacked containers generates a network of circulation channels for the worms, because of the particular shape of the recessed and bossed bottoms.

The peripheries of the surrounds of two adjacent containers that are vertical and extend over a sufficient height allow extremely rapid handling of the boxes. Specifically, they make it possible in particular to easily pick them up in groups of two, three or four with a single hand simply placing them one against another.

The zigzag empty spaces between two surrounds will, for their part, allow surplus water to flow out while making it possible to keep the bloodworms in position immobilized laterally in the packaging for example and allow them to breathe.

The latter cannot get out because of the narrowness of the zigzags.

In advantageous embodiments, use is also made of one or more of the following arrangements:
the surround comprises four rounded corners each furnished with a notch open that is downward.

Advantageously, each notch defines a coupling lip close to the top of said surround;
the stiffening lugs comprise, in the bottom part, a protruding portion in the form of a downward centering triangle;
the angle of the isosceles trapeziums is between 2° and 5°;
the upper face of the bottom of the container has one or two longitudinal portions projecting from said face, defining lateral channels with the walls.

Advantageously, its lower face, for its part, comprises the corresponding recessed portions for example so that the distance between the upper face of the underneath container and the lower face of the top container remain at a constant distance in the event of stacking;
the box also comprises a rectangular or substantially rectangular lid furnished with an overcapping rim extending toward the bottom and toward the outside of the lid, designed to interact by gentle friction with the periphery of the surround;
the overcapping rim comprises inward-protruding parts arranged so as to snap into the notches of the rounded corners.

The invention also proposes a packaging for example made of polystyrene, for containers belonging to boxes as described above, for example of at least four stacks of containers, for example of three to ten containers. The packaging can then advantageously be furnished with a lid as described below.

The invention also proposes a packaging for, and/or a system formed of, at least one stack of containers as described above that are open, filled with a dampened medium and with bloodworms, said containers being fitted into one another.

Such a stack allows the transport of live worms in containers with no lid, or possibly a lid as described above, for the top container of the stack, each top container serving as a lid for the underneath container.

Such a stack did not exist in the prior art, no user having thought of dispensing with the lid for boxes containing live worms.

With the containers according to the invention, which provide a space between the bottoms, and allows the worms to breathe, with no risk of seeing them come out of their packaging, a considerable saving in storage volume is possible, and simple and rapid transport to be used is obtained in the form of this stack.

The user therefore does not need to reopen the boxes to examine the worms and/or count them; he simply has to lift them.

The invention further and more particularly proposes a packaging for containers for bloodworms, characterized in that it comprises a polystyrene parallelepipedal case for retaining eight stacks of at least four of said open containers suitable for being first filled with a dampened medium and with bloodworms, said containers of one and the same stack being fitted into one another and the eight stacks being placed around a central cooling part for immobilizing stacks against the inner walls of the case, the upper edge of the case comprising a groove or a protrusion over the whole of its periphery, and in that it comprises a polystyrene lid the inner face of which comprises a protrusion of a groove suitable for interacting by interlocking with said protrusion or said groove of the periphery of the case and is furnished with a central flat protruding toward the inside of the case, pierced right through the lid in order to allow aeration, and arranged to interact with the central part in order to prevent any flow of liquid out of the case.

Advantageously, the packaging comprises eight stacks of ten open containers.

Equally advantageously, the packaging comprises, over at least one outer face, a transverse or longitudinal groove forming an aeration passageway between two packages stacked one on the other.

The invention will be better understood on reading the following description of embodiments given below as nonlimiting examples. It refers to the drawings which accompany it in which:

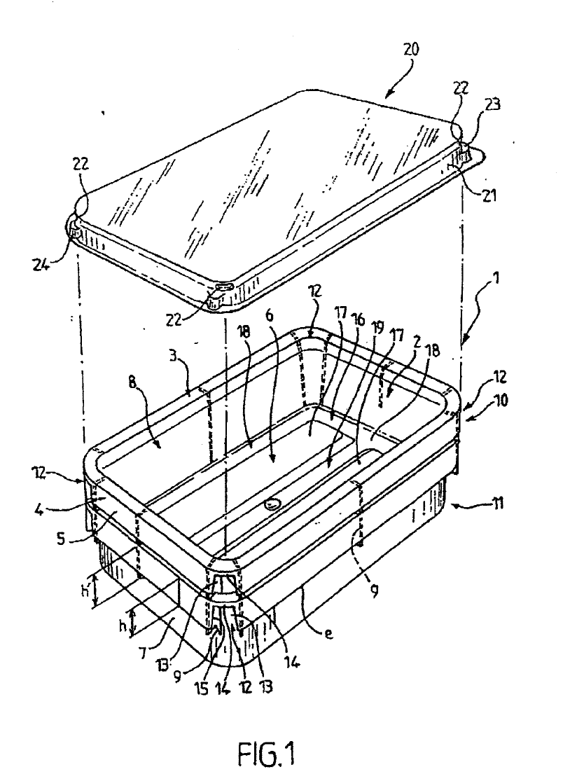

FIG. 1 is a view in perspective of two stacked containers, according to the embodiment of the invention more particularly described here, with a lid for packaging and final presentation to the client.

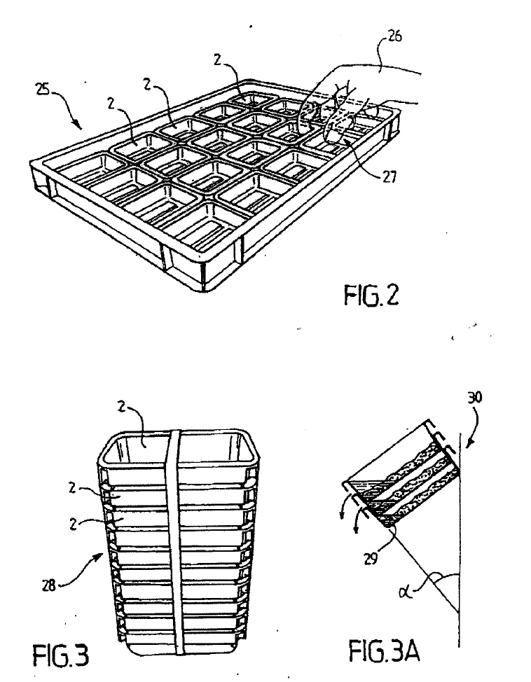

FIG. 2 shows a storage tray for containers of FIG. 1, flat, for filling and then for manual movement, for example four by four, and storage or stacking of said containers.

FIG. 3 shows a stack of stacked containers according to one embodiment of the invention.

FIG. 3A is a schematic view in section of the stack when it is rinsed.

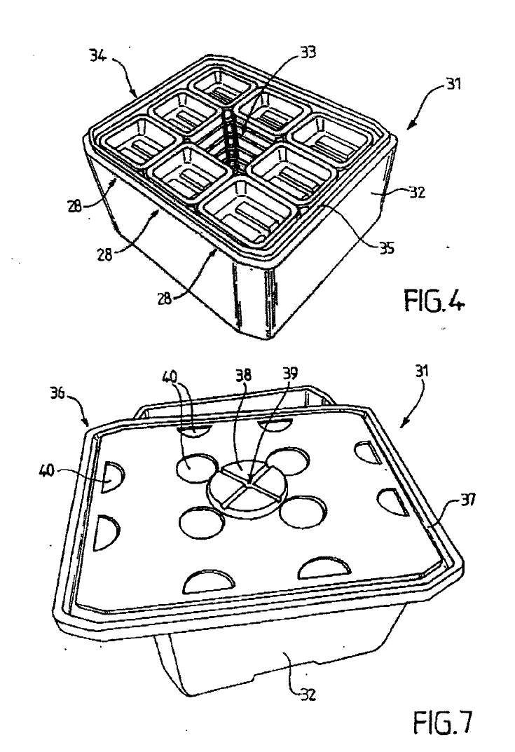

FIG. 4 is a view in perspective of a packaging for eight stacks of containers corresponding to FIG. 3.

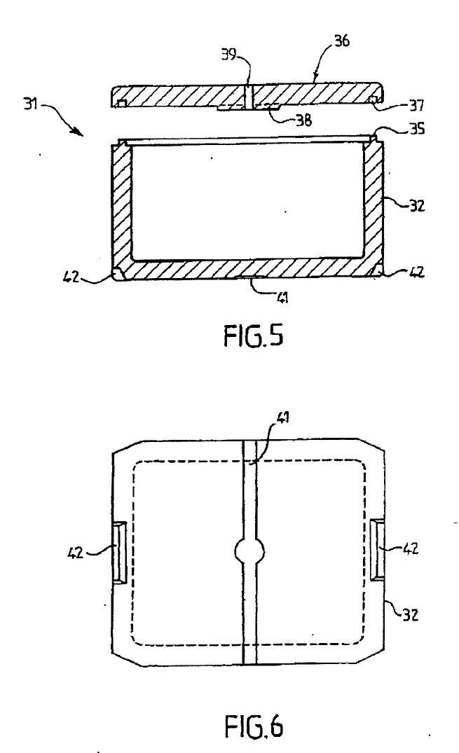

FIGS. 5 and 6 are respectively the views in section and from above of the packaging of FIG. 4.

FIG. 7 is a view in perspective of the packaging of FIG. 4 with the lid turned over.

FIG. 1 shows in particular a storage box 1 for bloodworms (not shown) made of substantially parallelepipedal plastic.

The box 1 comprises a container 2 for holding bloodworms and their medium (also not shown) of lateral and isosceles trapezoidal transverse section directed downward.

The container has an upper edge 3 furnished with a surround 4 of which the periphery 5 perpendicular to the bottom 6 is situated entirely at a distance from the outer face 7 of the lateral walls 8.

The walls 8 are solid, that is to say with no orifice or opening, making them perfectly watertight. They are for example made of transparent or translucent plastic.

The periphery 5 extends downward over a height h corresponding to a third of the height H of the container.

The surround 4 comprises stiffening lugs 9 perpendicular to the surround and with a length h′ greater than the height h of the surround so that, when the upper container 10 (also designated by reference number 2 above) is interlocked with a container called lower 11, the resting of the surround lugs 9 on the top of the lower surround 3 provides, on the one hand, a space for retaining the worms and their medium between the lower face of the upper container 10 and the upper face of the lower container 11, and, on the other hand, a zigzag empty space e between the volume of air trapped between said faces and the outside of the containers.

The lugs 9 are evenly distributed along the surround, for example and advantageously two lugs on either side of each corner and one lug centered on each of the longitudinal and transverse surround parts of the walls of the box.

In the embodiment more particularly described here, the surround 3 comprises four corners 12 each furnished with a notch 13 opening downward defining a coupling lip 14 close to the top 3 of said surround.

The stiffening lugs 9 comprise, in the bottom part, a portion 15 in the shape of a downward centering triangle when one container is interlocked into the other.

The angle of the isosceles trapeziums in the embodiment more particularly described here is 3°.

The upper face 16 of the bottom of the container has two longitudinal portions 17 projecting from said face, for example 3 to 5 mm, for example 4 mm thick in order to arrange, all around these two substantially parallelepipedal projecting portions, channels 18 with a width equal to ⅓ of that of the portions, said channels therefore being situated between said projecting portions 17 and the walls, and so as to arrange between the two projecting portions a central channel 19, for example of the same length and of the same width as the channels 18, so that a layer of medium will be able to be hollowed out between the projections by the worms when the latter are placed in the sand and in the container.

The container may also be furnished, when it is unstacked from the underneath containers, with a rectangular or substantially rectangular lid 20, furnished with overcapping edges 21 extending toward the bottom and toward the outside of the lid, capable of interacting by gentle friction with the periphery 5 of the surround 4, for example over the whole of its height.

A slight clearance is also possible.

The upper surface of the lid, made for example of transparent plastic, advantageously serves as a publicity medium and/or an indicator of the content of the box.

In the embodiment most particularly described here, the overcapping rim 21 also comprises inward-protruding parts 22 arranged to snap-fit into the notches 14 of the rounded corners 12.

The covering lid 20 also comprises small notch-shaped recesses 23 that will serve as a locator during the manufacture of the lids and which will also provide, between the rims 3 of the periphery of the surround and the volume of the lid, an additional space 24 allowing water to flow away during the rinsing with seawater of the containers and their content.

FIG. 2 shows a tray 25 furnished with four rows of five containers that are easy to pick up in fours. Thus the hand 26 of a user is capable of picking up a set of four containers 27 of a block, the peripheries 5 of the surrounds being pressed against one another in a precise manner, and thus allowing this particular grasp leading to a filling and an unfilling of the tray that is particularly fast and efficient.

The stability of the containers thus bonded to one another and their perfect vertical and horizontal alignment in this position allows extremely rapid and easy multiple stacking and unstacking.

FIG. 3 shows a stack 28 of ten containers 2 according to the invention, with no lid, that can be stacked on one another.

FIG. 3A shows schematically a portion of a stack pivoted at an angle α allowing the media to be dampened by virtue of the dosing, according to the angle α, of the quantity of water 29, capable of remaining inside the packaging.

By virtue of the configuration of the containers according to the invention, it is therefore possible to refresh and regenerate the worms quickly and efficiently.

It is possible in effect to entirely submerge the stack in seawater and then tilt it in order to discharge the water, so that all that remains in the packages is a small quantity of water 29, making it possible to maintain the dampness of the medium and therefore of the bloodworms stored therein.

Note that bloodworms are particularly delicate animals.

The plastic packaging as provided, which is particularly favorable to a medium in the form of damp sand, will allow the worms to go without food and at the same time will allow the damp waste that the latter will generate during the prolonged fast corresponding to their transport to be cleaned away.

This problem is not usually taken into account by the prior art which either does not deal with the case of the bloodworm, which demonstrates that it has not identified the specific problem posed by the latter, or wrongly amalgamates them with earthworms.

In order to live, the bloodworm needs tides and considerable oxygenation which makes it grow only on coastlines in the zone that is conventionally called the “splash zone”.

Deprived of this environment, and if it is not stored in optimized conditions, it dies quickly.

With the boxes as proposed, which allow it to survive in the best way possible, and being able to be easily redampened, with a calculated degree of hydrometry [according to the angle α of tipping of the stack (cf. FIG. 3A)], while allowing aeration for the worms to breathe, by virtue of the spaces that are arranged between the surround and walls, the worms are well conserved.

A description will now be given with reference to FIGS. 4, 5, 6 and 7 of a parallelepipedal polystyrene packaging 31 for containers as described above.

The latter comprises a parallelepipedal case 32 which allows the storage of a set of containers for bloodworms, namely eight stacks 28 of at least four of said containers 2.

Said containers are first opened and filled with a dampened medium and with bloodworms (not shown) and then interlocked with one another as has been seen with reference to FIG. 3 in order to form eight stacks of ten boxes.

The latter are then placed around a cooling part (not shown) that is central for immobilizing the stacks against the inner walls of the case, placed in the central recess 33 formed between the adjacent stacks.

The upper edge 33 of the case 32 comprises a protrusion 34 over the whole of its periphery, for example of 2 to 3 mm and even 1 cm in height.

This will <> a perfectly watertight closure at the case/lid junction.

The packaging 31 specifically and in addition comprises a lid 36 furnished on its periphery with a groove 37 capable of interacting by interlocking with the protrusion 34.

The lid 36 is furnished with a central flat 38, that is for example circular, protruding toward the inside of the case, pierced right through with a hole 39 to allow aeration.

It is arranged to interact with the central part (not shown) so as to block any flow of liquid toward the outside of the case allowing air transport in particular.

Small recesses 40, in the shape of a circle toward the centre or in the shape of a half-moon toward the periphery, are also advantageously placed in a distributed manner in order to promote aeration between the boxes, straddling, in the closed position of the lid over the peripheries of the surrounds, two or three adjacent containers.

The case 32 also comprises, on at least one outer face, a longitudinal transverse groove 41 forming an aeration passageway between stacked packages, and small lateral recesses 42 allowing the case to be firmly gripped during handling operations.

The application and the operation of the containers and the packaging according to the invention will now be described.

After having placed the containers flat on a tray 25 allowing their transport and their filling, for example in series of twenty, the latter are filled, for example in a semiautomatic manner, with a medium product for example formed of dry sand, which is then dampened with corresponding doses of seawater.

Since the containers are designed to accommodate of the order of five to eight worms, the doses of dry sand are for example between 25 g and 40 g, advantageously 30 to 32 g, the quantities of damping water then being of the order of 5 to 15 ml of seawater, advantageously 7 to 10 ml.

In another embodiment, the quantities of dry sand and of water may for example be simultaneously doubled.

The worms have in fact been observed to hold up well for proportions between sand and water of 25 to 30% in weight of water for 100% in weight of sand.

This dampening or redampening may be obtained by submerging the stack 28, for example strapped together by an elastic element, in order to keep the containers fixed together, in a tank of seawater, then by disposing of the surplus by tilting the containers at an angle α, for example 45° (see FIG. 3A).

Once the containers of the tray 25 have been filled with the medium material, the live worms are placed in the containers, counted as they go in.

They will rapidly be able to bury themselves between the projecting portions 17, finding their damp and protective natural surroundings.

The containers are then picked up manually (see FIG. 2) rapidly and easily in order to form by stacking four stacks in one go.

These stacks are then placed in the case 32 while arranging a central recess which allows, on the one hand, the easy placement and extraction of the stacks, and, on the other hand a location for a refrigeration block known per se, which also immobilizes the stacks in the packaging. The closure of the lid 36, in a watertight manner because of the groove 37/protrusion 34 interlocking, is then carried out and will, after tying down and taping of the lid with the case passing through small recesses 42, allow air transport that complies with very demanding applicable standards.

After transport, the packages are opened by the retailer who has only to extract them while checking them visually.

He can then refresh them and rinse them as described above and unstack the containers as required while reclosing them with lids gradually in line with his sales requirements.

As goes without saying and as results from the foregoing, the present invention is not limited to the embodiment more particularly described. On the contrary, it covers all the variants and in particular those in which the packaging comprises more containers and/or stacks of containers.

1. A storage box (1) for bloodworms, made of substantially parallelepipedal plastic, characterized in that it comprises a container (2, 10, 11) for retaining the bloodworms and their medium of isosceles trapezoidal lateral, longitudinal and transverse sections directed downward, said container having solid walls with an upper edge (3) furnished with a surround (4) the periphery (5) of which is perpendicular to the bottom (6) and situated entirely at a distance from the outer face (7) of the lateral walls (8), and extends downward over a height of between ¼ and ⅔ of the height (H) of said container, said surround comprising stiffening lugs (9) perpendicular to said surround, evenly placed along said surround, and with a length h′ greater than the height of said surround, said lugs being arranged so that, when the “upper” container (10) is fitted onto a “lower” container (11), the resting of the lugs (9) of the upper surround on the top of the lower surround provides on the one hand a space for retaining the worms and their medium between the lower face of the upper container and the upper face of the lower container and, on the other hand, a zigzag empty space (e) between the volume of air trapped between said faces and the outside of the containers.

2. The box as claimed in claim 1, characterized in that the surround (4) comprises four rounded corners (12) each furnished with a notch (13) that is open downward defining a coupling lip (14) close to the top of said surround.

3. The box as claimed in either one of the preceding claims, characterized in that the stiffening lugs (9) comprise, in the bottom part, a protruding portion (15) in the form of a downward centering triangle.

4. The box as claimed in any one of the preceding claims, characterized in that the angle of the isosceles trapeziums is between 2° and 5°.

5. The box as claimed in any one of the preceding claims, characterized in that the upper face (16) of the bottom (6) of the container has one or two longitudinal portions (17) projecting from said face.

6. The box as claimed in any one of the preceding claims, characterized in that it also comprises a rectangular or substantially rectangular lid (20) furnished with a rim (21) extending toward the bottom and toward the outside of the lid, designed to interact by gentle friction with the periphery (5) of the surround.

7. The box as claimed in claim 6, dependent on claim 2, characterized in that the overcapping rim (21) comprises inward-protruding parts (22) arranged so as to snap into the notches (13) of the rounded corners (12).

8. A system formed by at least one stack of open containers, characterized in that said containers are previously filled with a dampened medium and are suitable for containing bloodworms, in that said containers are fitted into one another, each belonging to a box as claimed in any one of claims 1 to 5.

9. The system as claimed in claim 8, characterized in that the top container of the stack also comprises a lid.

10. The system as claimed in claim 9, characterized in that the lid of the top container is as claimed in claim 6.

11. The system as claimed in claim 10, characterized in that the overcapping rim of the top box comprises inward-protruding parts (22) arranged to snap into the notches (13) of the rounded corners (12).

12. A packaging (31) for a set of containers (2) for bloodworms belonging to boxes as claimed in any one of claims 1 to 5, characterized in that it comprises a polystyrene parallelepipedal case (32) for retaining eight stacks (28) of at least four of said open containers suitable for being first filled with a dampened medium and with bloodworms, said containers of one and the same stack being fitted into one another and the eight stacks being placed around a central cooling part (28) for immobilizing stacks against the inner walls of the case, the upper edge (33) of the case comprising a groove or a protrusion (34) over the whole of its periphery, and in that it comprises a polystyrene lid (36) the inner face of which comprises a groove (37) suitable for interacting by interlocking with said protrusion of the periphery of the case and is furnished with a central flat (38) protruding toward the inside of the case, pierced right through the lid in order to allow aeration, and arranged to interact with the central part in order to prevent any flow of liquid out of the case.

13. The packaging as claimed in claim 12, characterized in that it comprises eight stacks (28) of ten open containers.

14. The packaging as claimed in either one of claims 12 and 13, characterized in that it comprises, over at least one outer face, a transverse or longitudinal groove (41) forming an aeration passageway.
